(19) United States
(12) Patent Application Publication
(10) Pub. No.: US 2004/0052948 A1
(43) Pub. Date: Mar. 18, 2004

(54) Electronic device manufacture

(75) Inventors: Dana A. Gronbeck, Holliston, MA (US); Michael K. Gallagher, Hopkinton, MA (US); Jeffrey M. Calvert, Acton, MA (US); Christopher P. Sullivan, Randolph, MA (US)

Correspondence Address: S. Matthew Cairns, c/o EDWARDS & ANGELL, LLP, P.O. Box 9169, Boston, MA, 02209, US

(73) Assignee: Shipley Company, L.L.C.

(21) Appl. No.: 10/453,300

(22) Filed: Jun. 3, 2003

Related U.S. Application Data
(60) Provisional application No. 60/385,367, filed on Jun. 3, 2002.

(51) Int. Cl. B05D 3/00

(52) U.S. Cl. 427/299; 427/402

(57) ABSTRACT

Treatment procedures for organic polysilica layers are provided that improve the adhesion of layers of material that are subsequently applied to the treated organic polysilica layers. In particular, layers of organic polymeric material have improved adhesion to such treated organic polysilica layers. These treatment procedures are particularly useful in the manufacture of electronic devices, such as integrated circuits, wherein the organic polysilica layers are used as dielectric materials, cap layers, etch stops and the like.

### BACKGROUND OF THE INVENTION

The present invention relates generally to the field of manufacture of electronic and optical devices. In particular, the present invention relates to the manufacture of devices with low dielectric constant material or low refractive index material.

As electronic devices become smaller, there is a continuing desire in the electronics industry to increase the circuit density in electronic components, e.g., integrated circuits, circuit boards, multichip modules, chip test devices, and the like without degrading electrical performance, e.g., crosstalk or capacitive coupling, and also to increase the speed of signal propagation in these components. One method of accomplishing these goals is to reduce the dielectric constant of the interlayer, or intermetal, insulating material used in the components.

A variety of organic and inorganic porous dielectric materials are known in the art in the manufacture of electronic devices, particularly integrated circuits. Suitable inorganic dielectric materials include silicon dioxide and organic polysilicas. Suitable organic dielectric materials include thermosets such as polyimides, polyarylene ethers, polyarylenes, polycyanurates, polybenzazoles, benzocyclobutenes, fluorinated materials such as poly(fluoroalkanes), and the like. Of the organic polysilica dielectrics, the alkyl silsesquioxanes such as methyl silsesquioxane are of increasing importance because of their low dielectric constant.

A method for reducing the dielectric constant of interlayer, or intermetal, insulating material is to incorporate within the insulating film very small, uniformly dispersed pores or voids. In general, such porous dielectric materials are prepared by first incorporating a removable porogen into a B-staged dielectric material, disposing the B-staged dielectric material containing the removable porogen onto a substrate, curing the B-staged dielectric material and then removing the porogen to form a porous dielectric material. For example, U.S. Pat. Nos. 5,895,263 (Carter et al.) and 6,271,273 (You et al.) disclose processes for forming integrated circuits containing porous organic polysilica dielectric material. In conventional processes, the dielectric material is typically cured under a non-oxidizing atmosphere, such as nitrogen, and optionally in the presence of an amine in the vapor phase to catalyze the curing process.

After the porous dielectric material is formed, it is subjected to conventional processing conditions of patterning, etching apertures, optionally applying a barrier layer and/or seed layer, metallizing or filling the apertures, planarizing the metallized layer, and then applying a cap layer or etch stop. These process steps may then be repeated to form another layer of the device.

A disadvantage of certain dielectric materials, including organic polysilica dielectric materials, is that other materials used in subsequent processing steps do not always sufficiently adhere to the surface of the dielectric material to allow for subsequent processing. For example, conventional polymeric materials such as photoresists and antireflective coatings do not readily adhere to the surface of dielectric materials containing methyl silsesquioxane, resulting in non-uniform layers of such polymeric materials. Such non-uniform layers may have areas totally devoid of photoresist or antireflective coating material and other areas where excessive polymeric material has built up. Uniform layers of photoresists and antireflective coatings are needed for subsequent patterning of the dielectric materials. Also, additional layers, such as cap layers, hard masks, etch stops and the like, may not adhere sufficiently to the cured organic polysilica dielectric layer. These additional layers may be comprised of a variety of materials such as hydrido-, alkyl- or aryl-silsesquioxanes, or organic dielectrics. Alternatively, these additional layers may be comprised of silicon-containing materials that are deposited from vapor-phase processes such as chemical vapor deposition (“CVD”), where the deposited layers are compounds of silicon having substantial proportions of one or more additional elements such as carbon, oxygen and nitrogen. Typical of such layers are silicon oxide, silicon carbide, silicon nitride, silicon oxycarbide, silicon oxynitride and silicon carbonitride. Methyl silsesquioxane has not achieved widespread use in electronic devices because of this adherence problem.

There is thus a need for an improved process for manufacturing electronic devices containing organic polysilica dielectric materials. There is further a need for improving the adherence of subsequently applied layers, whether such layers are organic polymeric materials, inorganic materials or organic-inorganic materials, to organic polysilica dielectric materials. The subsequently applied layers may be deposited onto the organic polysilica dielectric layers using either liquid or vapor-phase deposition processes.

U.S. Pat. No. 5,262,201 (Chandra et al.) discloses a low temperature process for converting silica precursor coatings to ceramic silica coatings by exposing the uncured silica precursor coatings to ammonium hydroxide, or a mixture of ammonia and water, and then heating the preceramic coating to convert the preceramic coating to a ceramic coating. In this patent, only the preceramic silica coatings (i.e. uncured silica coatings) are exposed to ammonium hydroxide or ammonia-water mixtures. This patent does not disclose a method of improving the adhesion of coatings to organic polysilica dielectric materials.

In U.S. Pat. No. 6,329,280 (Cook et al.) it is disclosed that known photoresist developers attack silsesquioxane materials. According to this patent, the amount of silsesquioxane removed by such developers is not controllable and such developers may undercut the resist pattern resulting in distorted features. This patent uses a thin oxide layer to prevent resist developers from reaching the silsesquioxane. The thin oxide layer can be deposited during plasma treatment, such as by removing the resist using an oxygen-containing plasma or reactive ion etch containing fluorocarbons. This patent fails to recognize the adhesion problem of subsequently applied layers to an organic polysilica material.

### SUMMARY OF THE INVENTION

It has been surprisingly found that electronic devices containing dielectric material including organic polysilica dielectric material, such as alkyl and/or aryl silsesquioxane, can be prepared according to the present invention with the use of conventional subsequently applied layers such as polymeric materials such as photoresists and antireflective coatings. Uniform coatings of such subsequently applied layers have been achieved according to the present invention.

The present invention provides a method for manufacturing a device including an organic polysilica layer including the step of contacting the organic polysilica layer with one or more adhesion promoters prior to disposing a layer of material on the organic polysilica layer.

In another aspect, the present invention provides a method for manufacturing an electronic device including the steps of: a) disposing on a substrate one or more B-staged organic polysilica dielectric materials; b) at least partially curing the one or more B-staged organic polysilica materials to form an organic polysilica layer; and c) contacting the organic polysilica dielectric layer with one or more adhesion promoters prior to disposing a layer of material on the organic polysilica dielectric layer.

In a further aspect, the present invention provides a method for improving the adhesion of materials to organic polysilica layers including the step of contacting the organic polysilica layer with one or more adhesion promoters prior to disposing a layer of material on the organic polysilica layer.

### BRIEF DESCRIPTION OF THE DRAWINGS

FIG. 1 illustrates a prior art electronic device after spin coating a conventional photoresist layer on a methyl silsesquioxane dielectric layer, not to scale.

FIG. 2 illustrates a prior art electronic device after spin coating a conventional photoresist layer on a porous methyl silsesquioxane dielectric layer, not to scale.

FIG. 3 illustrates an electronic device after spin coating a conventional photoresist layer on a methyl silsesquioxane dielectric layer contacted with an oxidant prior according to this invention, not to scale.

FIG. 4 illustrates an electronic device after spin coating a conventional photoresist layer on a porous methyl silsesquioxane dielectric layer contacted with an oxidant according to this invention, not to scale.

FIG. 5 is a plot showing the change in water contact angle of an organic polysilica film with contact time of an adhesion promoter of the invention.

### DETAILED DESCRIPTION OF THE INVENTION

As used throughout this specification, the following abbreviations shall have the following meanings, unless the context clearly indicates otherwise: ° C.=degrees centigrade; UV=ultraviolet; nm=nanometer; g=gram; wt %=weight percent; L=liter; μm=micron=micrometer; rpm=revolutions per minute; N=normal; DI=deionized; MΩ=milliohm; and ppm=parts per million.

The term “alkyl” includes straight chain, branched and cyclic alkyl groups. The term “porogen” refers to a pore forming material, that is a polymeric material or particle dispersed in a dielectric material that is subsequently removed to yield pores, voids or free volume in the dielectric material. Thus, the terms “removable porogen,” “removable polymer” and “removable particle” are used interchangeably throughout this specification. The terms “pore,” “void” and “free volume” are used interchangeably throughout this specification. “Cross-linker” and “cross-linking agent” are used interchangeably throughout this specification. “Polymer” refers to polymers and oligomers, and also includes homopolymers and copolymers. The terms “oligomer” and “oligomeric” refer to dimers, trimers, tetramers and the like. “Monomer” refers to any ethylenically or acetylenically unsaturated compound capable of being polymerized or other compound capable of being polymerized by condensation. Such monomers may contain one or more double or triple bonds or groups capable of being polymerized by condensation.

The term “B-staged” refers to uncured organic polysilica materials. By “uncured” is meant any material that can be polymerized or cured to form higher molecular weight materials, such as coatings or films. As used herein, “partially cured” refers to a film or coating of organic polysilica material that has been sufficiently cured so that only 1% or less of the thickness of the film is lost upon contact with a solvent suitable for dissolving the B-staged organic polysilica material. Such partially cured films or coatings may undergo further curing during subsequent processing steps. “Films” and “Layers” are used interchangeably throughout this Specification. B-staged materials may be monomeric, oligomeric or mixtures thereof. B-staged material is further intended to include mixtures of polymeric material with monomers, oligomers or a mixture of monomers and oligomers.

Unless otherwise noted, all amounts are percent by weight and all ratios are by weight. All numerical ranges are inclusive and combinable in any order, except where it is obvious that such numerical ranges are constrained to add up to 100%.

In conventional procedures for preparing electronic devices such as integrated circuits having organic polysilica dielectric material layers, B-staged organic polysilica dielectric material is first disposed on a substrate. The B-staged dielectric material is then cured typically in a non-oxidizing atmosphere, such as nitrogen, and optionally in the presence of a vapor phase amine catalyst to form a layer, coating or film of organic polysilica dielectric material on the substrate. Layers of materials that are subsequently applied by spin coating tend to show poor adherence to such cured organic polysilica layers. Exemplary of such subsequently applied spin coated layers are organic polymeric materials, inorganic (“spin-on-glass”) materials or organic-inorganic materials, such as organic antireflective coatings, photoresists, lift-off layers, etch stops, cap layers, hard masks and the like.

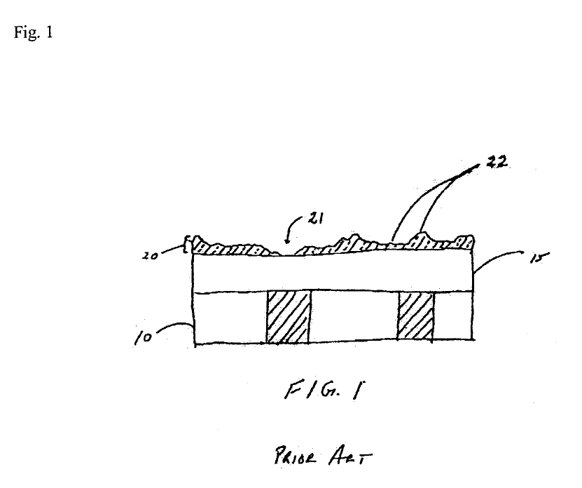

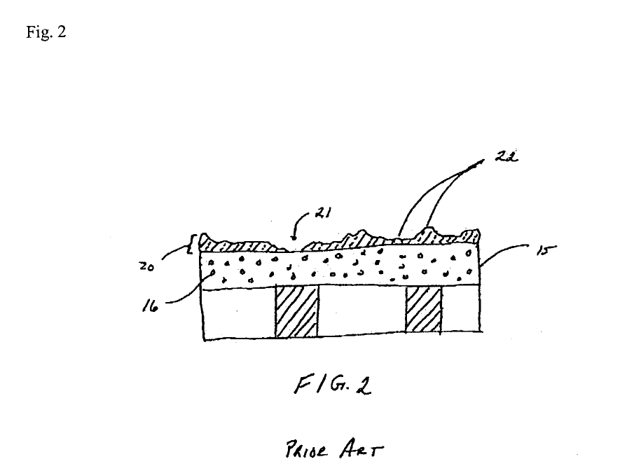

In a typical manufacturing step, an organic polysilica dielectric material, once cured, is next patterned. Patterning is well known to those skilled in the art and requires disposing a photoresist layer on the surface of the organic polysilica dielectric material and optionally an antireflective coating between the photoresist layer and the dielectric material. Polymeric materials such as photoresists and antireflective coatings used in subsequent processing steps do not adhere sufficiently to certain conventionally prepared organic polysilica dielectric materials, particularly those containing methyl silsesquioxane. When conventional photoresists are disposed, such as by spin coating, on the surface of methyl silsesquioxane dielectric material the photoresist does not typically provide a uniform coating. FIG. 1, not to scale, illustrates a conventional process for spin coating a conventional photoresist layer 20 on a methyl silsesquioxane dielectric film 15 disposed on a substrate 10 having metallic studs 12. The photoresist layer 20 typically has deficiencies or areas of little or missing photoresist 21 and areas of uneven thickness 22, exaggerated for clarity. FIG. 2, not to scale, illustrates a conventional process for spin coating a conventional photoresist layer 20 on a methyl silsesquioxane dielectric film 15 containing pores 16 and having areas of little or missing photoresist 21 and areas of uneven thickness 22, exaggerated for clarity. Such deficiencies are problematic for the patterning of such methyl silsesquioxane dielectric material, whether porous or dense. As used herein, “dense” organic polysilica refers to organic polysilica layers that are not intentionally made porous, such as by the use of removable porogens, surfactants or excess solvents.

Organic polysilica materials are also used in the manufacture of optical devices, such as waveguides, diffraction gratings, optical switching devices, and the like. In certain of these optical applications, such as waveguides, the device requires a core material surrounded by a cladding material. The cladding material has a lower index of refraction than the core material, the difference in the refractive indices being necessary to contain the light within the core. Organic polysilica materials may be used for either the core or cladding material in such applications. Additionally, many optical devices have a hermetic sealing layer to prevent or reduce moisture absorption by the optical materials. As these materials absorb moisture over time the optical loss may increase to unacceptable levels. Clearly, good adhesion, such as between the core and cladding layers and hermetic sealing layers and the optical materials, is a requirement for the proper functioning of these optical devices.

These problems are reduced or avoided by the present invention. The present invention provides a method for manufacturing an electronic or optical device including an organic polysilica layer including the step of contacting the organic polysilica layer with one or more adhesion promoters prior to disposing a layer of material on the organic polysilica layer. It will be appreciated that one or more layers of material may be disposed on the organic polysilica layer following treatment with the adhesion promoter. In another embodiment, the present invention provides a method for manufacturing an electronic or optical device including the steps of: a) disposing on a substrate one or more B-staged organic polysilica materials; b) at least partially curing the one or more B-staged organic polysilica materials to form an organic polysilica layer; and c) contacting the organic polysilica layer with one or more adhesion promoters. Throughout this specification, “device” refers to both an electronic device and an optical device unless the context clearly indicates only one particular type of device is meant.

By “organic polysilica resin” (or organo siloxane) is meant a compound including silicon, carbon, oxygen and hydrogen atoms. Exemplary organic polysilica resins are chosen from hydrolyzates and partial condensates of one or more silanes of formulae (I) or (II):

RₐSiY₄₋ₐ (I)

R¹_{b}(R²O)_{3-b}Si(R³)_{c}Si(OR⁴)_{3-d}R⁵_{d} (II)

wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 0 to 2; R¹, R², R⁴ and R⁵ are independently selected from hydrogen, (C₁-C₆)alkyl, (C₇-C₁₂)arylalkyl, substituted (C₇-C₁₂)arylalkyl, aryl, and substituted aryl; R³ is selected from (C₁-C₁₀)alkyl, —(CH₂)ₕ—, —(CH₂)ₕ₁—Eₖ—(CH₂)ₕ₂—, —(CH₂)ₕ—Z, arylene, substituted arylene, and arylene ether; E is selected from oxygen, NR⁶ and Z; Z is selected from aryl and substituted aryl; R⁶ is selected from hydrogen, (C₁-C₆)alkyl, aryl and substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen. “Substituted arylalkyl”, “substituted aryl” and “substituted arylene” refer to an arylalkyl, aryl or arylene group having one or more of its hydrogens replaced by another substituent group, such as cyano, hydroxy, mercapto, halo, (C₁-C₆)alkyl, (C₁-C₆)alkoxy, and the like.

It is preferred that R is (C₁-C₄)alkyl, benzyl, hydroxybenzyl, phenethyl or phenyl, and more preferably methyl, ethyl, iso-butyl, tert-butyl or phenyl. Preferably, a is 1. Suitable hydrolyzable groups for Y include, but are not limited to, halo, (C₁-C₆)alkoxy, acyloxy and the like. Preferred hydrolyzable groups are chloro and (C₁-C₂)alkoxy. Suitable organosilanes of formula (I) include, but are not limited to, methyl trimethoxysilane, methyl triethoxysilane, phenyl trimethoxysilane, phenyl triethoxysilane, tolyl trimethoxysilane, tolyl triethoxysilane, propyl tripropoxysilane, iso-propyl triethoxysilane, iso-propyl tripropoxysilane, ethyl trimethoxysilane, ethyl triethoxysilane, iso-butyl triethoxysilane, iso-butyl trimethoxysilane, tert-butyl triethoxysilane, tert-butyl trimethoxysilane, cyclohexyl trimethoxysilane, cyclohexyl triethoxysilane, benzyl trimethoxysilane, benzyl triethoxysilane, phenethyl trimethoxysilane, hydroxybenzyl trimethoxysilane, hydroxyphenylethyl trimethoxysilane and hydroxyphenylethyl triethoxysilane.

Organosilanes of formula (II) preferably include those wherein R¹ and R⁵ are independently (C₁-C₄)alkyl, benzyl, hydroxybenzyl, phenethyl or phenyl. Preferably R¹ and R⁵ are methyl, ethyl, tert-butyl, iso-butyl and phenyl. It is also preferred that b and d are independently 1 or 2. Preferably R³ is (C₁-C₁₀)alkyl, —(CH₂)ₕ—, arylene, arylene ether and —(CH₂)ₕ₁—E—(CH₂)ₕ₂. Suitable compounds of formula (II) include, but are not limited to, those wherein R³ is methylene, ethylene, propylene, butylene, hexylene, norbomylene, cycloheylene, phenylene, phenylene ether, naphthylene and —CH₂—C₆H₄—CH₂—. It is further preferred that c is 1 to 4.

Suitable organosilanes of formula (II) include, but are not limited to, bis(hexamethoxysilyl)methane, bis(hexaethoxysilyl)methane, bis(hexaphenoxysilyl)methane, bis(dimethoxymethylsilyl)methane, bis(diethoxymethylsilyl)methane, bis(dimethoxyphenylsilyl)methane, bis(diethoxyphenylsilyl)methane, bis(methoxydimethylsilyl)methane, bis(ethoxydimethylsilyl)methane, bis(methoxydiphenylsilyl)methane, bis(ethoxydiphenylsilyl)methane, bis(hexamethoxysilyl)ethane, bis(hexaethoxysilyl)ethane, bis(hexaphenoxysilyl)ethane, bis(dimethoxymethylsilyl) ethane, bis(diethoxymethylsilyl)ethane, bis(dimethoxyphenylsilyl)ethane, bis(diethoxyphenylsilyl)ethane, bis(methoxydimethylsilyl)ethane, bis(ethoxydimethylsilyl)ethane, bis(methoxydiphenylsilyl)ethane, bis(ethoxydiphenylsilyl)ethane, 1,3-bis(hexamethoxysilyl))propane, 1,3-bis(hexaethoxysilyl)propane, 1,3-bis(hexaphenoxysilyl)propane, 1,3-bis(dimethoxymethylsilyl)propane, 1,3-bis(diethoxymethylsilyl)propane, 1,3-bis(dimethoxyphenylsilyl)propane, 1,3-bis(diethoxyphenylsilyl)propane, 1,3-bis(methoxydimehylsilyl)propane, 1,3-bis(ethoxydimethylsilyl)propane, 1,3-bis(methoxydiphenylsilyl)propane, and 1,3-bis(ethoxydiphenylsilyl)propane. Preferred of these are hexamethoxydisilane, hexaethoxydisilane, hexaphenoxydisilane, 1,1,2,2-tetramethoxy-1,2-dimethyldisilane, 1,1,2,2-tetraethoxy-1,2-dimethyldisilane, 1,1,2,2-tetramethoxy-1,2-diphenyldisilane, 1,1,2,2-tetraethoxy-1,2-diphenyldisilane, 1,2-dimethoxy-1,1,2,2-tetramethyldisilane, 1,2-diethoxy-1,1,2,2-tetramethyldisilane, 1,2-dimethoxy-1,1,2,2-tetraphenyldisilane, 1,2-diethoxy-1,1,2,2-tetraphenyldisilane, bis(hexamethoxysilyl)methane, bis(hexaethoxysilyl)methane, bis(dimethoxymethylsilyl)methane, bis(diethoxymethylsilyl)methane, bis(dimethoxyphenylsilyl)methane, bis(diethoxyphenylsilyl)methane, bis(methoxydimethylsilyl)methane, bis(ethoxydimethylsilyl)methane, bis(methoxydiphenylsilyl)methane, and bis(ethoxydiphenylsilyl)methane.

When the B-staged organic polysilica resins include one or more of a hydrolyzate and partial condensate of organosilanes of formula (II), c may be 0, provided that at least one of R¹ and R⁵ are not hydrogen. In an alternate embodiment, the B-staged organic polysilica resins may include one or more of a cohydrolyzate and partial cocondensate of organosilanes of both formulae (I) and (II). In such cohydrolyzates and partial cocondensates, c in formula (II) can be 0, provided that at least one of R, R¹ and R⁵ is not hydrogen. Suitable silanes of formula (II) where c is 0 include, but are not limited to, hexamethoxydisilane, hexaethoxydisilane, hexaphenoxydisilane, 1,1,1,2,2-pentamethoxy-2-methyldisilane, 1,1,1,2,2-pentaethoxy-2-methyldisilane, 1,1,1,2,2-pentamethoxy-2-phenyldisilane, 1,1,1,2,2-pentaethoxy-2-phenyldisilane, 1,1,2,2-tetramethoxy-1,2-dimethyldisilane, 1,1,2,2-tetraethoxy-1,2-dimethyldisilane, 1,1,2,2-tetramethoxy-1,2-diphenyldisilane, 1,1,2,2-tetraethoxy- 1,2-diphenyldisilane, 1,1,2-trimethoxy-1,2,2-trimethyldisilane, 1,1,2-triethoxy-1,2,2-trimethyldisilane, 1,1,2-trimethoxy-1,2,2-triphenyldisilane, 1,1,2-triethoxy-1,2,2-triphenyldisilane, 1,2-dimethoxy-1,1,2,2-tetramethyldisilane, 1,2-diethoxy-1,1,2,2-tetramethyldisilane, 1,2-dimethoxy-1,1,2,2-tetraphenyldisilane, and 1,2-diethoxy- 1,1,2,2-tetraphenyldisilane.

In one embodiment, particularly suitable B-staged organic polysilica resins are chosen from hydrolyzates and partial condensates of compounds of formula (I). Such B-staged organic polysilica resins have the formula (III):

((R⁷R⁸SiO)ₑ(R⁹SiO_{1.5})_{f}(R¹⁰SiO_{1.5})_{g}(SiO₂)ᵣ)ₙ (III)

wherein R⁷, R⁸, R⁹ and R¹⁰ are independently selected from hydrogen, (C₁-C₆)alkyl, (C₇-C₁₂)arylalkyl, substituted (C₇-C₁₂)arylalkyl, aryl, and substituted aryl; e, g and r are independently a number from 0 to 1; f is a number from 0.2 to 1; n is integer from 3 to 10,000; provided that e+f+g+r=1; and provided that at least one of R⁷, R⁸ and R⁹ is not hydrogen. In the above formula (III), e, f, g and r represent the mole ratios of each component. Such mole ratios can be varied between 0 and 1. It is preferred that e is from 0 to 0.8. It is also preferred that g is from 0 to 0.8. It is further preferred that r is from 0 to 0.8. In the above formula, n refers to the number of repeat units in the B-staged material. Preferably, n is an integer from 3 to 1000.

Suitable organic polysilica resins include, but are not limited to, silsesquioxanes, partially condensed halosilanes or alkoxysilanes such as partially condensed by controlled hydrolysis tetraethoxysilane having number average molecular weight of 500 to 20,000, organically modified silicates having the composition RSiO₃, O₃SiRSiO₃, R₂SiO₂ and O₂SiR₃SiO₂ wherein R is an organic substituent, and partially condensed orthosilicates having Si(OR)₄ as the monomer unit. Silsesquioxanes are polymeric silicate materials of the type RSiO_{1.5} where R is an organic substituent. Suitable silsesquioxanes are alkyl silsesquioxanes such as methyl silsesquioxane, ethyl silsesquioxane, propyl silsesquioxane, butyl silsesquioxane and the like; aryl silsesquioxanes such as phenyl silsesquioxane and tolyl silsesquioxane; alkyl/aryl silsesquioxane mixtures such as a mixture of methyl silsesquioxane and phenyl silsesquioxane; and mixtures of alkyl silsesquioxanes such as methyl silsesquioxane and ethyl silsesquioxane. B-staged silsesquioxane materials include homopolymers of silsesquioxanes, copolymers of silsesquioxanes or mixtures thereof. Such materials are generally commercially available or may be prepared by known methods.

In an alternate embodiment, the organic polysilica resins may contain a wide variety of other monomers in addition to the silicon-containing monomers described above. For example, the organic polysilica resins may further comprise cross-linking agents, and carbosilane moieties. Such cross-linking agents may be any of the cross-linking agents described elsewhere in this specification, or any other known cross-linkers for silicon-containing materials. It will be appreciated by those skilled in the art that a combination of cross-linkers may be used. Carbosilane moieties refer to moieties having a (Si—C)ₓ structure, such as SiR₃CH₂—, —SiR₂CH₂—, ═SiRCH₂—, and ═SiCH₂—, where R is usually hydrogen but may be any organic or inorganic radical. These carbosilane moieties are typically connected “head-to-tail”, i.e. having Si—C—Si bonds, in such a manner that a complex, branched structure results. Particularly useful carbosilane moieties are those having the repeat units (SiHₓCH₂) and (SiH_{y-1}(CH═CH₂)CH₂), where x=0 to 3 and y=1 to 3. These repeat units may be present in the organic polysilica resins in any number from 1 to 100,000, and preferably from 1 to 10,000. Suitable carbosilane precursors are those disclosed in U.S. Pat. Nos. 5,153,295 (Whitmarsh et al.) and 6,395,649 (Wu).

It is preferred that the B-staged organic polysilica resin comprises a silsesquioxane, and more preferably methyl silsesquioxane, ethyl silsesquioxane, propyl silsesquioxane, iso-butyl silsesquioxane, tert-butyl silsesquioxane, phenyl silsesquioxane, tolyl silsesquioxane, benzyl silsesquioxane or mixtures thereof. Methyl silsesquioxane, phenyl silsesquioxane and mixtures thereof are particularly suitable. Other useful silsesquioxane mixtures include mixtures of hydrido silsesquioxanes with alkyl, aryl or alkyl/aryl silsesquioxanes. Typically, the silsesquioxanes useful in the present invention are used as oligomeric materials, generally having from 3 to 10,000 repeating units.

Particularly suitable organic polysilica B-staged resins are chosen from one or more of co-hydrolyzates and partial condensates of one or more organosilanes of formulae (I) and/or (II) and one or more tetrafunctional silanes having the formula SiY₄, where Y is any hydrolyzable group as defined above. Suitable hydrolyzable groups include, but are not limited to, halo, (C₁-C₆)alkoxy, acyloxy and the like. Preferred hydrolyzable groups are chloro and (C₁-C₂)alkoxy. Suitable tetrafunctional silanes of the formula SiY₄ include, but are not limited to, tetramethoxysilane, tetraethoxysilane, tetrachlorosilane, and the like. Particularly suitable silane mixtures for preparing the co-hydrolyzates and partial co-condensates include: methyl triethoxysilane and tetraethoxysilane; methyl trimethoxysilane and tetramethoxysilane; phenyl triethoxysilane and tetraethoxysilane; methyl triethoxysilane and phenyl triethoxysilane and tetraethoxysilane; ethyl triethoxysilane and tetramethoxysilane; and ethyl triethoxysilane and tetraethoxysilane. The ratio of such organosilanes to tetrafunctional silanes is typically from 99:1 to 1:99, preferably from 95:5 to 5:95, more preferably from 90:10 to 10:90, and still more preferably from 80:20 to 20:80.

In a particular embodiment, the B-staged organic polysilica resin is chosen from one or more of a co-hydrolyzate and partial co-condensate of one or more organosilanes of formula (I) and a tetrafunctional silane of formula SiY₄. In another embodiment, the B-staged organic polysilica resin is chosen from one or more of a co-hydrolyzate and partial co-condensate of one or more organosilanes of formula (II) and a tetrafunctional silane of formula SiY₄. In still another embodiment, the B-staged organic polysilica resin is chosen from one or more of a co-hydrolyzate and partial co-condensate of one or more organosilanes of formula (I), one or more silanes of formula (II) and a tetrafunctional silane of formula SiY₄. The B-staged organic polysilica resins of the present invention include a non-hydrolyzed or non-condensed silane of one or more silanes of formulae (I) or (II) with the one or more of hydrolyzates and partial condensates of one or more silanes of formulae (I) or (II). In a further embodiment, the B-staged organic polysilica resin comprises a silane of formula (II) and a hydrolyzate of partial condensate of one or more organosilanes of formula (I), and preferably a co-hydrolyzate or partial co-condensate of one or more organosilanes of formula (I) with a tetrafunctional silane of the formula SiY₄ where Y is as defined above. Preferably, such B-staged organic polysilica resin comprises a mixture of one or more silanes of formula (II) and one or more of a co-hydrolyzate and partial co-condensate having the formula (RSiO_{1.5}) (SiO₂) where R is as defined above.

When organosilanes of formula (I) are co-hydrolyzed or co-condensed with a tetrafunctional silane, it is preferred that the organosilane of formula (I) has the formula RSiY₃, and preferably is selected from methyl trimethoxysilane, methyl triethoxysilane, ethyl trimethoxysilane, ethyl triethoxysilane, phenyl trimethoxysilane, phenyl triethoxysilane and mixtures thereof. It is also preferred that the tetrafunctional silane is selected from tetramethoxysilane and tetraethoxysilane.

It will be appreciated that prior to any curing step, the B-staged organic polysilica resins may include one or more of hydroxyl or alkoxy end capping or side chain functional groups. Such end capping or side chain functional groups are known to those skilled in the art.

The B-staged organic polysilica materials are disposed on a substrate by any suitable means, such as, but not limited to, spin coating, spray coating or doctor blading. Such disposing means typically provide a film, layer or coating of B-staged material. The B-staged organic polysilica materials may be disposed on a substrate as is, but are typically combined with one or more organic solvents and/or optionally one or more porogens to form a B-staged composition. Any solvent that dissolves, disperses, suspends or otherwise is capable of delivering the B-staged organic polysilica materials to the substrate is suitable. Such organic solvents are well known in the art and include, but are not limited to, ketones such as methyl isobutyl ketone, diisobutyl ketone, cyclohexanone, and 2-heptanone, lactones such as γ-butyrolactone and γ-caprolactone, esters such as ethyl lactate, propyleneglycol monomethyl ether acetate, n-amyl acetate, n-butyl acetate, ethers such as diphenyl ether and anisole, glycol ethers such as propyleneglycol monomethyl ether, N-methyl-2-pyrrolidone, N,N′-dimethylpropyleneurea, aromatic hydrocarbons such as mesitylene, toluene, and xylenes, and mixtures of solvents. Alternatively, solvents may consist of highly pressurized gases, such as supercritical carbon dioxide, with one or more co-solvents or additives to provide the desired solvency properties. It is preferred that a composition including one or more B-staged organic polysilica materials and one or more organic solvents is disposed on a substrate. Once such a composition is disposed on the substrate, the solvent may be removed prior to or during the step of curing the B-staged organic polysilica material.

Substrates suitable for the present invention include, but are not limited to: silicon, silicon dioxide, silicon carbide, silicon oxynitride, silicon germanium, silicon on insulator, glass, silicon nitride, silicon oxynitride, silicon carbonitride, ceramics, aluminum, copper, compound semiconductors such as gallium arsenide, plastics such as polycarbonate, circuit boards, such as FR-4 and polyimide, and hybrid circuit substrates, such as aluminum nitride-alumina. Such substrates may further include thin films deposited thereon, such films including, but not limited to: metal nitrides, metal carbides, metal silicides, metal oxides, and mixtures thereof. In a multilayer integrated circuit device, an underlying layer of insulated, planarized circuit lines can also function as a substrate.

After being deposited on a substrate, the B-staged material is then at least partially cured to form a rigid, cross-linked material. Such cured organic polysilica material is typically a coating or film. The organic polysilica material may be cured by a variety of means such as by heating in an oven or on a hot plate, by plasma treatment, irradiation with infrared or microwave radiation, or by corona discharge. When the organic polysilica material is thermally cured, it is typically heated at a temperature of up to 750° C. A particularly useful temperature range for thermal curing is from 130° to 450° C. Alternatively, the organic polysilica dielectric material may be cured by treatment with a plasma. During such plasma treatment, the organic polysilica material may optionally be heated. Such curing conditions are known to those skilled in the art and are dependent upon the particular B-staged organic polysilica material chosen.

The cured organic polysilica layer is next contacted with one or more adhesion promoters prior to the deposition of a layer of any subsequent material. As used herein, “adhesion promoter” refers to any compound that lowers the water contact angle of the organic polysilica material as compared to the water contact angle prior to treatment with the adhesion promoter. In general, the adhesion promoters are agents which function to increase the surface hydrophilicity, i.e. decrease the water contact angle, of the organic polysilica layer. While not intending to be bound by theory, it is believed that such increase in hydrophilicity is due to the hydrolytic transformation of a Si—O—Si or Si—H bond to a Si—OH bond. One skilled in the art will recognize that the present invention improves the adhesion of subsequently applied layers to a treated organic polysilica layer, regardless of the actual mechanism of the surface chemistry.

In general, the organic polysilica layer is contacted with the adhesion promoter for a period of time sufficient to lower the water contact angle of the organic polysilica layer. The exact amount of time necessary depends upon the particular organic polysilica employed as well as the specific adhesion promoter selected, the concentration of the adhesion promoter and the temperature of the adhesion promoter. It will be appreciated by those skilled in the art that increasing the concentration of the adhesion promoter in an adhesion promoter composition will shorten the contact time.

Typically, the water contact angle for cured organic polysilica materials is from 80 to 105° or even higher, as measured on a commercially available contact angle goniometer, such as the Kernco G-I-1000 Goniometer, using the manufacturer's procedures and a 1 minute equilibration time. In general, such contact angle measurements have an error of ±1%. Any lowering of the water contact angle will provide increased adhesion of subsequently applied layers of materials as well as provide better coating uniformity of such layers of materials on the organic polysilica layer. Preferably, the water contact angle is lowered by 10° or greater and more preferably by 20° or greater. In another embodiment, it is preferred that the water contact angle is lowered to less than or equal to 70° following contact with the adhesion promoter. It is more preferred that the water contact angle of the organic polysilica material is from 20 to 70°, even more preferably from 20 to 65°, and still more preferably less than or equal to 20 to 60° following contact with the adhesion promoter.

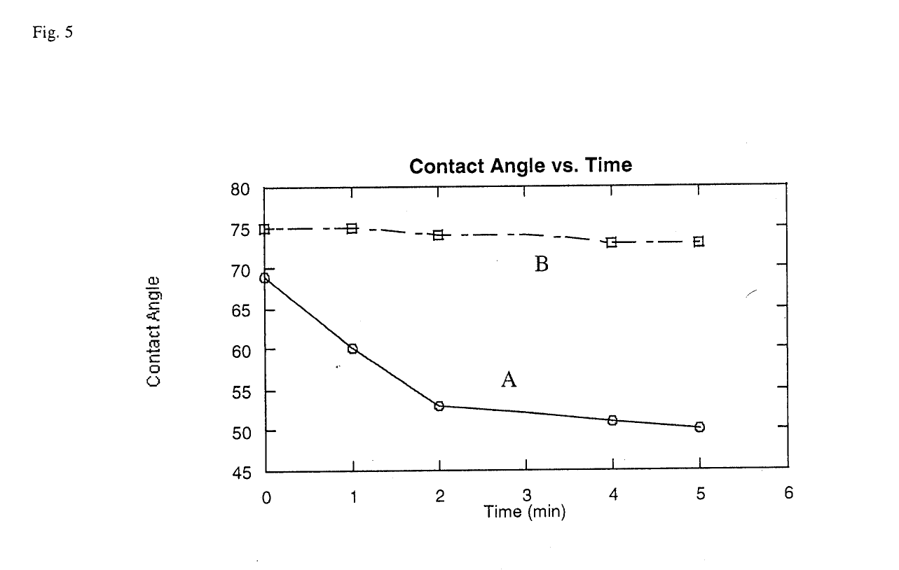

The effect of the present adhesion promoters on lowering the water contact angle of organic polysilica materials is illustrated in FIG. 5. A cured porous organic polysilica film comprising methyl silsesquioxane was contacted with an aqueous 0.26 N tetramethylammonium hydroxide solution, either containing a surfactant, line A, or surfactant-free, line B. The water contact angles of the film were measured after different contact times with the adhesion promoter. This plot shows that the water contact angle decreases with time, i.e. the longer the organic polysilica material is in contact with the adhesion promoter, the greater the lowering of the water contact angle. Accordingly, the present invention can be used to provide organic polysilica materials having a desired water contact angle for optimum adhesion and coatability. A desired water contact angle can be achieved by monitoring the water contact angle as a function of adhesion promoter contact time until the desired water contact angle is obtained.

There is, of course, a limit to how far the water contact angle can be lowered. Such limit will depend upon the surface chemistry of the organic polysilica material selected, as well as on the ability of the adhesion promoter to affect the hydrophilicity of the surface of such material. It will be appreciated by those skilled in the art that the term “surface” refers to not only the very top portion of a film, but also some thickness of the film itself. For example, the adhesion promoters will affect the top of the film and will also affect the hydrophilicity of the film to some depth of the film, such depth being generally less than the total thickness of the film.

A wide variety of adhesion promoters may be used, including, but not limited to, oxidants, acids, bases and a mixture of an oxidant and acid. While not necessary, mixtures of oxidants, mixtures of acids or mixtures of bases may be used. Peroxides such as hydrogen peroxide and tert-butyl hydroperoxide are suitable oxidants. Suitable acids include sulfuric acid, nitric acid and the like. Preferably, the adhesion promoter is a base, such as an amine. Preferred bases are those having a pKa of greater than or equal to 10. Exemplary bases include, but are not limited to, hydroxylamine, alkali metal hydroxides such as sodium hydroxide and potassium hydroxide, tetraalkylammonium hydroxides such as tetramethylammonium hydroxide, and the like. It will be appreciated by those skilled in the art that hydroxylamine may be used as a salt such as hydroxylamine hydrochloride, hydroxylamine phosphate, hydroxylamine nitrate or hydroxylamine sulfate. Aqueous hydrogen peroxide-sulfuric acid mixtures may also be suitably be used. Such adhesion promoters are generally commercially available as photoresist developers or strippers, such as from Shipley Company (Marlborough, Mass.) and Shipley-SVC (Sunnyvale, Calif.).

The adhesion promoter is typically applied to the at least partially cured organic polysilica layer as a liquid composition. The adhesion promoter composition may be aqueous, organic solvent based, supercritical fluid based, or a mixture of water and water-miscible organic solvent. Any solvent that dissolves the adhesion promoter may be used. Suitable solvents include, but are not limited to, ketones such as cyclohexanone, methyl isobutyl ketone, diisobutyl ketone and 2-heptanone, lactones such as γ-butyrolactone and γ-caprolactone, esters such as n-amyl acetate, n-butyl acetate, ethyl acetate and ethyl lactate, glycol ether acetates such as propyleneglycol monomethyl ether acetate, ethers and glycol ethers such as propyleneglycol monomethyl ether, diphenyl ether and anisole, aromatic hydrocarbons such as mesitylene and xylenes, alcohols, glycols such as diethylene glycol, triethylene glycol, dipropylene glycol, tripropylene glycol and their higher molecular weight homologues, and the like. The adhesion promoter may be present in such liquid compositions in a wide range of concentrations. Typically, the amount of adhesion promoter is sufficient to provide a 0.1 to 1 N composition. Aqueous adhesion promoter compositions are preferred, and particularly aqueous compositions containing an adhesion promoter in an amount of 0.15 to 0.26 N. The adhesion promoter composition is preferably metal ion-free.

The adhesion promoter composition optionally includes one or more surfactants or wetting agents. Any surfactant, such as nonionic, cationic, anionic and amphoteric, may be used. Nonionic surfactants are preferred, such as ethylene oxide (“EO”) or propylene oxide (“PO”) polymers or copolymers of EO/PO. Particularly useful surfactants are those sold under the PLURONIC and TETRONIC brands by BASF, Ludwigshafen, Germany. It will be appreciated by those skilled in the art that the surfactants may be used to buffer or tailor the pKa of the adhesion promoter composition to a desired value. It is preferred that the adhesion promoter compositions include one or more nonionic surfactants. Such surfactants may decrease the time required for the adhesion promoter to lower the water contact angle of the organic polysilica material. The amount of such surfactants or wetting agents may vary over a wide range, but typically are less than or equal to 20% by weight of the total adhesion promoter composition.

The organic polysilica layer is contacted with one or more adhesion promoters by any suitable means, such as by dipping, spraying, spin coating, roller coating, brushing, and the like. The adhesion promoter may be used at a wide variety of temperatures, such as from ambient to 10° C. lower than the boiling point of the adhesion promoter composition. Ambient temperature is quite suitable for many applications.

After contact with the adhesion promoter, the organic polysilica layer is optionally but preferably rinsed. Such rinse may be a water rinse such as with DI water, an acidic rinse such as with formic acid, acetic acid, lactic acid, citric acid and the like, or a basic rinse. If an acidic adhesion promoter composition is used, it is preferred that the rinse is basic. Likewise, if a basic adhesion promoter composition is used, it is preferred that the rinse is acidic. A combination of rinsing steps may be employed, such as a first water rinse, an acidic rinse and a second water rinse. It is further preferred that an acidic or basic rinse is used, followed by a water rinse.

When partially cured organic polysilica films are used, they may be further cured after contact with the adhesion promoter. Such further curing step may be prior to, during or subsequent to the step of applying a material to the organic polysilica film.

In another embodiment, the organic polysilica layers may be porous. Such porous layers have reduced dielectric constants and lower refractive indices as compared with the same material in the absence of pores. Porous organic polysilica layers are typically prepared by first incorporating a removable porogen into a B-staged organic polysilica material, disposing the B-staged organic polysilica material containing the removable porogen onto a substrate, curing the B-staged material and then removing the polymer to form a porous organic polysilica material. Thus, it is preferred that the B-staged organic polysilica materials of the present invention further include one or more porogens.

The porogens useful in the present invention are any which may be removed providing voids, pores or free volume in the organic polysilica material chosen and reduce the dielectric constant (“k”) of such material. A low-k dielectric material is any material having a dielectric constant less than 4.

A wide variety of removable porogens may be used in the present invention. The removable porogens may be porogen polymers or particles or may be co-polymerized with an organic polysilica dielectric monomer to form a block copolymer having a labile (removable) component. Preferably, the removable porogen is substantially non-aggregated or non-agglomerated in the B-staged material. Such non-aggregation or non-agglomeration reduces or avoids the problem of killer pore or channel formation in the dielectric matrix. It is preferred that the removable porogen is a porogen particle. It is further preferred that the porogen particle is substantially compatible with the B-staged material. By “substantially compatible” is meant that a composition of B-staged material and porogen is slightly cloudy or slightly opaque. Preferably, “substantially compatible” means at least one of a solution of B-staged material and porogen, a film or layer including a composition of B-staged material and porogen, a composition including a matrix material having porogen dispersed therein, and the resulting porous material after removal of the porogen is slightly cloudy or slightly opaque. To be compatible, the porogen must be soluble or miscible in the B-staged material, in the solvent used to dissolve the B-staged material or both. Suitable compatibilized porogens are those disclosed in U.S. Pat. No. 6,271,273 (You et al.) and European Patent Application EP Application No. 1 088 848 (Allen et al.). Preferably, the compatibilized porogen includes as polymerized units at least one compound selected from silyl-containing monomers or poly(alkylene oxide) monomers. Other suitable removable particles are those disclosed in U.S. Pat. No. 5,700,844.

Substantially compatibilized porogens, typically have a molecular weight in the range of 5,000 to 1,000,000, preferably 10,000 to 500,000, and more preferably 10,000 to 100,000. The polydispersity of these materials is in the range of 1 to 20, preferably 1.001 to 15, and more preferably 1.001 to 10. It is preferred that such substantially compatibilized porogens are cross linked. Typically, the amount of cross-linking agent is 1% by weight or greater, based on the weight of the porogen. Up to and including 100% cross-linking agent, based on the weight of the porogen, may be effectively used in the particles of the present invention. It is preferred that the amount of cross-linker is from 1% to 80%, and more preferably from 1% to 60%.

Suitable block copolymers having labile components are those disclosed in U.S. Pat. Nos. 5,776,990 and 6,093,636. Such block copolymers may be prepared, for example, by using as pore forming material highly branched aliphatic esters that have functional groups that are further functionalized with appropriate reactive groups such that the functionalized aliphatic esters are incorporated into, i.e. copolymerized with, the vitrifying polymer matrix.

The removable porogens are typically added to the B-staged organic polysilica materials of the present invention in an amount sufficient to provide the desired lowering of the dielectric constant. For example, the porogens may be added to the B-staged materials in any amount of from 1 to 90 wt %, based on the weight of the B-staged material, preferably from 10 to 80 wt %, more preferably from 15 to 60 wt %, and even more preferably from 20 to 30 wt %.

When the removable porogens are not components of a block copolymer, they may be combined with the B-staged organic polysilica material by any methods known in the art. Typically, the B-staged material is first dissolved in a suitable high boiling solvent, such as methyl isobutyl ketone, diisobutyl ketone, 2-heptanone, γ-butyrolactone, γ-caprolactone, ethyl lactate propyleneglycol monomethyl ether acetate, propyleneglycol monomethyl ether, diphenyl ether, anisole, n-amyl acetate, n-butyl acetate, cyclohexanone, N-methyl-2-pyrrolidone, N,N′-dimethylpropyleneurea, mesitylene, xylenes, or mixtures thereof to form a solution. The porogens are then dispersed or dissolved within the solution. The resulting composition (e.g. dispersion, suspension or solution) is then deposited on a substrate by methods known in the art for depositing B-staged dielectric materials.

To be useful as porogens in forming porous organic polysilica materials, the porogens must be at least partially removable under conditions which do not adversely affect the organic polysilica material, preferably substantially removable, and more preferably completely removable. By “removable” is meant that the polymer depolymerizes or otherwise breaks down into volatile components or fragments which are then removed from, or migrate out of, the organic polysilica material yielding pores. Such resulting pores may fill with any carrier gas used in the removal process. Any procedures or conditions which at least partially remove the porogen without substantially degrading the organic polysilica material, that is, where less than 5% by weight of the dielectric material is lost, may be used. It is preferred that the porogen is substantially removed. Typical methods of removal include, but are not limited to: exposure to heat, pressure or radiation such as, but not limited to, actinic, IR, microwave, UV, x-ray, gamma ray, alpha particles, neutron beam or electron beam. It will be appreciated that more than one method of removing the porogen or polymer may be used, such as a combination of heat and actinic radiation. It is preferred that the dielectric material is exposed to heat or UV light to remove the porogen. It will also be appreciated by those skilled in the art that other methods of porogen removal, such as by atom abstraction, may be employed.

The porogens can be thermally removed under vacuum, nitrogen, argon, mixtures of nitrogen and hydrogen, such as forming gas, or other inert or reducing atmosphere, as well as under oxidizing atmospheres. Preferably, the porogens are removed under inert or reducing atmospheres. The porogens may be removed at any temperature that is higher than the thermal curing temperature and lower than the thermal decomposition temperature of the dielectric matrix material. Typically, the porogens may be removed at temperatures in the range of 150° to 450° C. and preferably in the range of 250° to 425° C. Under preferable thermal porogen removal conditions, the organic polysilica dielectric material is heated to a temperature of 350° to 400° C. It will be recognized by those skilled in the art that the particular removal temperature of a thermally labile porogen will vary according to composition of the porogen. Such heating may be provided by means of an oven or microwave. Typically, the porogens are removed upon heating for a period of time in the range of 1 to 120 minutes. After removal from the organic polysilica material, 0 to 20% by weight of the porogen typically remains in the porous organic polysilica material.

In another embodiment, when a porogen is removed by exposure to radiation, the porogen polymer is typically exposed under an inert atmosphere, such as nitrogen, to a radiation source, such as, but not limited to, visible or ultraviolet light. While not intending to be bound by theory, it is believed that porogen fragments form, such as by radical decomposition, and are removed from the material under a flow of inert gas. The energy flux of the radiation must be sufficiently high such that porogen particles are at least partially removed.

Upon removal of the porogens, a porous organic polysilica material having pores is obtained, where the size of the pores is preferably substantially the same as the particle size (diameter) of the porogen, i.e. within 50% of the size of the porogen. The resulting organic polysilica material having pores thus has a lower dielectric constant than such material without such voids. In general, pore sizes of up to 1,000 nm, such as that having a mean particle size in the range of 0.5 to 1000 nm, are obtained. It is preferred that the mean pore size is in the range of 0.5 to 200 nm, more preferably from 0.5 to 50 nm, and most preferably from 1 nm to 20 nm.

The porogen may be removed any time after curing of the B-staged organic polysilica material. For example, the porogens may suitably be removed during or after curing of the B-staged organic polysilica material, after exposure, after etching, after barrier or seed layer deposition, after aperture fill or metallization, or after planarization.

The reduced water contact angles resulting from the present invention provide for better coating uniformity of subsequent layers of material, i.e., such subsequently applied materials will form essentially uniform layers across the surface of the organic polysilica layers. Also, these reduced water contact angles result in an organic polysilica layers having greatly improved adhesion to subsequently applied layers of material. Thus, any subsequently applied material, such as antireflective coatings, photoresists, lift-off layers, cap layers, hard masks, etch stops, optical cladding layers, hermetic sealing layers, dielectric layers and the like, will coat the organic polysilica layers treated according to the invention more uniformly and have better adhesion to such layers as compared to untreated organic polysilica layers. It will be appreciated by those skilled in the art that the present invention will also improve the adhesion between different organic polysilica layers.

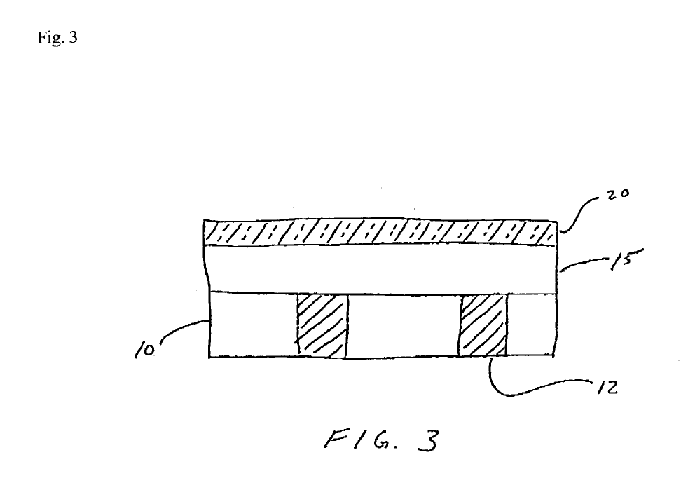

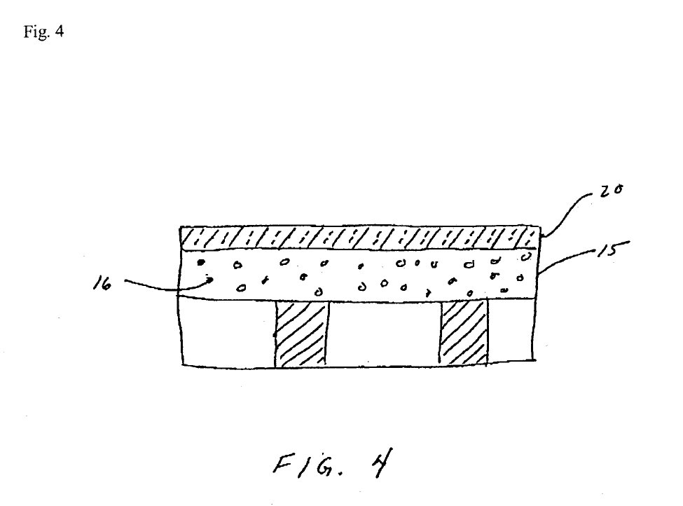

An advantage of the present invention is that conventional polymeric materials used in patterning processes, i.e. conventional photoresists and antireflective coatings, have sufficient adherence to the treated organic polysilica layer to allow patterning of the dielectric material. For example, FIG. 3 illustrates a uniform photoresist layer 20 on the surface of an organic polysilica material 15 disposed on a substrate 10 containing vertical metal studs 12, not to scale. Likewise, FIG. 4 illustrates a uniform photoresist layer 20 on the surface of an organic polysilica material 15 containing pores 16, not to scale. Such pores 16 are not shown to scale and are shown as substantially spherical. It will be appreciated that the pores in such porous dielectric material may be any suitable shape, preferably substantially spherical and more preferably spherical. While the above Figures are illustrative of photoresists, the same is true for other materials applied to organic polysilica layers, such as antireflective coatings, hard masks, lift-off layers, cap layers, etch stops and the like.

Thus, in another embodiment, the present invention provides a method for improving the adhesion of materials to organic polysilica layers including the step of contacting the organic polysilica layer with one or more adhesion promoters prior to disposing a layer of material on the organic polysilica layer.

Organic polysilica layers are typically used as interlayer dielectrics in the manufacture of integrated circuits. However, such organic polysilica layers may also be used as cap layers, hard masks, etch stops, CMP stops, waveguides, optical interconnects, encapsulants, and the like. Such organic polysilica layers are also useful in printed wiring board manufacture, such as in waveguides, optical interconnects, and the like. It will be appreciated that the organic polysilica layers may be used in different ways within the same electronic device. For example, an organic polysilica layer may be an interlayer dielectric and a second organic polysilica layer may be used as a cap layer. In such cases, each organic polysilica layer may be treated according to the present invention. In a preferred embodiment, a organic polysilica layer used as an interlayer dielectric in the manufacture of an integrated circuit is treated with an adhesion promoter, optionally rinsed, and then a second layer or organic polysilica as a cap layer is disposed on the organic polysilica dielectric layer. This organic polysilica cap layer is then contacted with the one or more adhesion promoters of the present invention. Such electronic device structure may then be processed according to conventional methods.

In a further embodiment, the present invention provides a method of manufacturing an integrated circuit including the steps of: a) disposing on a substrate one or more B-staged organic polysilica dielectric materials; and b) at least partially curing the one or more B-staged organic polysilica dielectric materials to form an organic polysilica dielectric layer; c) contacting the organic polysilica dielectric layer with one or more adhesion promoters; and then d) disposing a B-staged organic polysilica cap layer material on the organic polysilica dielectric layer. The B-staged cap layer is then at least partially cured as described above to form an organic polysilica cap layer on the organic polysilica dielectric layer. The cap layer is typically then contacted with one or more adhesion promoters in the same manner as the dielectric layer. In such a process, either the B-staged organic polysilica dielectric layer or the B-staged organic polysilica cap layer or both B-staged layers may contain porogens. Accordingly, the dielectric layer or the cap layer or both layers may be porous.

In the manufacture of electronic devices, a variety of cap layers may be applied to an organic polysilica dielectric. Thus, the present invention is also directed to a method of manufacturing an integrated circuit including the steps of: a) disposing on a substrate one or more B-staged organic polysilica dielectric materials; and b) at least partially curing the one or more B-staged organic polysilica dielectric materials to form an organic polysilica dielectric layer; c) contacting the organic polysilica dielectric layer with one or more adhesion promoters; and then d) applying a cap layer to the organic polysilica dielectric layer. Suitable cap layers include organic polysilica materials, silicon carbide, carbosilane-based materials, polyarylene ethers, silicon dioxide, polyimides, and the like. Multiple cap layers may also be used. For example, two or more cap layers, such a silicon carbide layer and a silicon dioxide layer, may be deposited on an organic polysilica dielectric material treated according to the present invention. Inorganic or organic cap layers may be applied by CVD or spin-on techniques.

The greatly improved adhesion of the organic polysilica materials treated according to the present invention allows for the formation of structures that are conventionally incompatible due to their poor adhesion to each other. For example, a multi-layer insulating structure having a first organic polysilica layer, such as a methylsilsesquioxane film, with a second organic polysilica layer disposed directly on the first organic polysilica layer can be prepared according to the present invention, wherein the first and second layers have sufficient adhesion to each other to not delaminate during subsequent processing, such during the steps of lithography, etching or planarization. Such adhesion is a result of the bond between the two layers without the need for additional mechanical fasteners such as dummy plugs as those disclosed in U.S. Pat. No. 6,258,715 (Yu et al.). Thus, an advantage of the present invention is that insulating structures including multiple adjacent layers of organic polysilica material can be prepared, thus avoiding the need for non-organic polysilica adhesive layers disposed between the organic polysilica layers. As an example, U.S. patent application Ser. No. 2001/0051447 discloses overcoming the adhesion deficiencies of a methyl silsesquioxane film by applying a layer of a polysiloxane material containing an Si—H group. Such non-organic polysilica adhesive layers are thus avoided by the present invention.

In still another embodiment, the cured organic polysilica material is patterned. Such patterning typically involves (i) coating the dielectric material layer with a positive or negative photoresist, such as those marketed by Shipley Company; (ii) imagewise exposing, through a mask, the photoresist to radiation, such as light of appropriate wavelength or e-beam; (iii) developing the image in the resist, e.g., with a suitable developer; and (iv) transferring the image through the dielectric layer to the substrate with a suitable transfer technique such as reactive ion etching. Such etching creates apertures in the dielectric material. Optionally, an antireflective coating is disposed between the photoresist layer and the dielectric matrix material. In the alternative, an antireflective coating may be applied to the surface of the photoresist. Such lithographic patterning techniques are well known to those skilled in the art. Following the image transfer step, various cleaning techniques are typically employed to remove residues from the patterned dielectric layer. Cleaning materials and methods may be either solution or plasma based processes, or a combination of both. These materials and methods are well-known to those skilled in the art.

After the apertures are formed in the dielectric material, barrier and/or seed layers may optionally be deposited. Such barrier layers are typically formed from conductive or non-conductive materials, such as tantalum and tantalum alloys, titanium and titanium alloys, tungsten and tungsten alloys, and are deposited by chemical vapor deposition or physical vapor deposition techniques. Seed layers, when used, may be applied to the dielectric material as the first metal layer or applied to a previously deposited barrier layer. Suitable seed layers include copper or copper alloys. When a seed layer is used without a barrier layer, it is preferred that the seed layer is not copper. Such seed layers may also be deposited by chemical vapor deposition (“CVD”) or physical vapor deposition (“PVD”) and are thin as compared to metallization layers. Alternatively, seed layers may be applied electrolessly. Such seed layers include catalysts for subsequent electroless plating, such as electroless metallization or filling of the apertures.

Following such barrier and/or seed layer deposition, the aperture may be metallized or filled with highly conductive metals such as with copper, silver, or alloys of copper or silver, including copper-silver alloys. Such metallization may be by any means, but is preferably at least partially electrolytic, and more preferably electrolytic. Methods of metallizing such apertures are well known to those skilled in the art. For example, ULTRAFILL™ 2001 EP copper deposition chemistries, available from Shipley Company, may be used for electrolytic copper metallization of apertures. In the alternative, the apertures may be metallized or filled electrolessly without the need for barrier or seed layers. If apertures are electrolessly metallized with copper, a barrier layer is preferred.

The deposited metal layer is typically planarized, such as by chemical mechanical polishing (“CMP”) or electropolishing. Such techniques are well known to those skilled in the art.

The following examples are presented to illustrate further various aspects of the present invention, but are not intended to limit the scope of the invention in any aspect.

### EXAMPLE 1

Silicon wafers (8 inch or 20 cm diameter) were spin coated with an organic polysilica composition containing 30% solids of methyl silsesquioxane co-condensed with a tetraalkoxyorthosilicate in an organic solvent using a commercially available coating track. The organic polysilica composition contained a certain amount of a compatible porogen by weight, reported in the Table. The composition was spin coated on the wafers at 200 rpm and then a film was spread to a thickness of 1200 nm at 3000 rpm. Excess material was removed from the back side of the wafer using a conventional edge bead remover and back side rinse agent. The films were then processed on a hot plate at 90° C. to partially remove the solvent, followed by heating at 150° C. to partially cure the organic polysilica layer, and finally by heating in a furnace to remove any residual solvent, to finally cure the organic polysilica layer and to remove the porogen.

After this processing, contact angle measurements were made on the films using a water droplet. The contact angle is indicative of the surface energy and can indicate whether a second coating such as a photoresist can be applied successfully on the surface and generate a uniform film. The organic polysilica layers were then contacted with an adhesion promoter composition comprising 0.26 N tetramethylammonium hydroxide in water with nonionic surfactant. The samples were then rinsed with DI water for 10 seconds and again baked at 150° C. for 1 minute. Water contact angles (using 18 MΩ DI water) were again determined. The results are reported in the Table.

TABLE

| | | | | Post-treated |
|---|---|---|---|---|
| | Amount of | Pre-treatment | Contact Time | Contact |
| Sample | Porogen (wt %) | Contact Angle | (seconds) | Angle |
| 1 | 22.5 | 94° | 30 | 53° |
| 2 | 22.5 | 94° | 120 | 50° |
| 3 | 45 | — | 30 | 58° |
| 4 | 45 | — | 120 | 53° |
| 5 | 22.5 | 94° | 60 | 52° |

From these data it can be clearly seen that the adhesion promoter treatment of the present invention greatly reduces the contact angle of the organic polysilica layer.

### EXAMPLE 2

An organic polysilica cap layer composition was disposed on Sample 5 from Example 1 to provide a cap layer having a thickness of 80 nm. The organic polysilica cap layer composition comprises 6% solids of methyl silsesquioxane co-condensed with a tetraalkoxyorthosilicate in a suitable solvent. The cap layer was cured according to the procedure of Example 1. The adhesion of the cap layer was evaluated using the ASTM standard tape pull test for adhesion (D 3359-97). Visual inspection showed that the tape did not remove any of the cap layer.

What is claimed is:

1. A method for manufacturing a device comprising an organic polysilica layer comprising the step of contacting the organic polysilica layer with one or more adhesion promotesr prior to disposing a layer of material on the organic polysilica layer.

2. The method of claim 1 wherein the adhesion promoter is a base.

3. The method of claim 2 wherein the base has a pKa of greater than or equal to 10.

4. The method of claim 1 wherein the organic polysilica layer comprises one or more of hydrolyzates and partial condensates of one or more silanes of formulae (I) or (II):
RₐSiY₄₋ₐ (I)
R¹_{b}(R²O)_{3-b}Si(R³)_{c}Si(OR⁴)_{3-d}R⁵_{d} (II)
wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 0 to 2; R¹, R², R⁴ and R⁵ are independently selected from hydrogen, (C₁-C₆)alkyl, aryl, and substituted aryl; R³ is selected from (C₁-C₁₀)alkyl, —(CH₂)ₕ—, —(CH₂)ₕ₁—Eₖ—(CH₂)ₕ₂—, —(CH₂)ₕ—Z, arylene, substituted arylene, and arylene ether; E is selected from oxygen, NR⁶ and Z; Z is selected from aryl and substituted aryl; R⁶ is selected from hydrogen, (C₁-C₆)alkyl, aryl and substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen.

5. The method of claim 1 further comprising the step of rinsing the organic polysilica layer after contact with the adhesion promoter.

6. The method of claim 1 wherein the organic polysilica layer is porous.

7. The method of claim 1 wherein the layer of material is an organic polysilica material.

8. A method for manufacturing an electronic device comprising the steps of: a) disposing on a substrate one or more B-staged organic polysilica dielectric materials; b) at least partially curing the one or more B-staged organic polysilica dielectric materials to form an organic polysilica dielectric layer; and c) contacting the organic polysilica dielectric layer with one or more adhesion promoters; and the d) disposing a layer of material on the organic polysilica layer.

9. The method of claim 8 wherein the adhesion promoter is a base.

10. The method of claim 9 wherein the base has a pKa of greater than or equal to 10.

11. The method of claim 8 wherein the organic polysilica layer comprises one or more of hydrolyzates and partial condensates of one or more silanes of formulae (I) or (II):
RₐSiY₄₋ₐ (I)
R¹_{b}(R²O)_{3-b}Si(R³)_{c}Si(OR⁴)_{3-d}R⁵_{d} (II)
wherein R is hydrogen, (C₁-C₈)alkyl, (C₇-C₁₂)arylalkyl, substituted (C₇-C₁₂)arylalkyl, aryl, and substituted aryl; Y is any hydrolyzable group; a is an integer of 0 to 2; R¹, R², R⁴ and R⁵ are independently selected from hydrogen, (C₁-C₆)alkyl, aryl, and substituted aryl; R³ is selected from (C₁-C₁₀)alkyl, —(CH₂)ₕ—, —(CH₂)ₕ₁—Eₖ—(CH₂)ₕ₂—, —(CH₂)ₕ—Z, arylene, substituted arylene, and arylene ether; E is selected from oxygen, NR⁶ and Z; Z is selected from aryl and substituted aryl; R⁶ is selected from hydrogen, (C₁-C₆)alkyl, aryl and substituted aryl; b and d are each an integer of 0 to 2; c is an integer of 0 to 6; and h, h1, h2 and k are independently an integer from 1 to 6; provided that at least one of R, R¹, R³ and R⁵ is not hydrogen.

12. The method of claim 8 wherein the B-staged organic polysilica material comprises porogens.

13. The method of claim 12 further comprising the step of removing the porogens to form a porous organic polysilica layer.

14. The method of claim 8 wherein the layer of material is a cap layer.

15. The method of claim 14 wherein the cap layer is organic or inorganic.

16. The method of claim 14 wherein the cap layer is deposited by CVD or spin-on techniques.

17. The method of claim 14 wherein either the B-staged organic polysilica dielectric material or the cap layer or both materials comprise a porogen.

18. The method of claim 8 further comprising the step of curing the layer of material.

19. A method for improving the adhesion of materials to organic polysilica layers comprising the step of contacting the organic polysilica layer with one or more adhesion promoters prior to disposing a layer of material on the organic polysilica layer.

20. The method of claim 19 wherein the wherein the adhesion promoter is a base.
